(19) United States
(12) Patent Application Publication
(10) Pub. No.: US 2024/0127430 A1
(43) Pub. Date: Apr. 18, 2024

(54) STOMA AND PERISTOMAL IMAGING AND QUANTIFICATION OF SIZE, SHAPE, AND COLOR

(71) Applicant: Hollister Incorporated, Libertyville, IL (US)

(72) Inventors: Joshua Everts, South Edina, MN (US); Arvind Krishnan, Sacramento, CA (US); Ash Rose, Berkeley, CA (US); Adrian P. Defante, Chicago, IL (US); Abram D. Janis, Grayslake, IL (US)

(21) Appl. No.: 18/263,215

(22) PCT Filed: Mar. 4, 2022
(86) PCT No.: PCT/US2022/018907

§ 371 Date: Jul. 27, 2023

Related U.S. Application Data
(60) Provisional application No. 63/157,290, filed on Mar. 5, 2021.

(51) Int. Cl. G06T 7/00; G06T 7/564; G06T 7/90; G06T 17/00

(52) U.S. Cl. CPC G06T 7/0012; G06T 7/564; G06T 7/90; G06T 17/00; G06T 2207/20081; G06T 2207/20084; G06T 2207/30028

(57) ABSTRACT

A method of imaging a stoma and/or peristomal skin includes obtaining a 2D image of a stoma and generating a 3D image from the 2D image of the stoma. In generating a 3D image, the 2D image may be converted into a grayscale and plotted into the 3D image. The color or the stoma and peristomal skin can also be measured to diagnose or track changes indicative of health and disease. The 3D image of the stoma and/or peristomal skin can facilitate determination of peristomal and stomal conditions and assist in maintaining health thereof.

### CROSS-REFERENCE TO RELATED APPLICATION

This application is based upon and claims priority to U.S. Provisional Application No. 63/157,290 filed on Mar. 5, 2021, the entire contents thereof are incorporated herein by reference in their entireties for all purposes.

### BACKGROUND

The following description relates to tools and methods of imaging and measuring a stoma.

A small intestine is composed of three parts, with the duodenum being the first part, the jejunum being the second part, and the ileum which is attached to the colon (large intestine) being the last part. In normal circumstances, 90% of nutrients are absorbed within the first 150 cm of the small intestine, with 9-10 L of endogenous fluid entering the stoma, and 1.5 L of fluid exiting into the colon where 90% of the liquid is absorbed, eventually resulting in fecal excrement containing about 0.1 L of fluid. The fluid entering is primarily composed of bile, saliva, gastric and pancreatic juices, whose absorption in the small intestine is dependent on electrolyte transport and the intercellular space permeability. When an ileostomy is performed, around 200-700 mL of effluent is excreted daily, but this can vary over a wide range. Normal ileostomy effluent is primarily water (90%), with a 120 mL mmol/L sodium concentration. However, complications such as ileostomy diarrhea, cholelithiasis, urolithiasis, and more can affect the composition of the effluent.

An ostomy may be temporary, constructed in advance of a gastrointestinal surgery, or may be permanent. Due to the nature of ostomies' impact on patients' health and lifestyle, it is important to understand the effect of an ostomy on patient's quality of life. The function of the stoma, odor control, and appliance adequacy/fit are all important considerations when determining the patient's quality of life and are determined by preoperative, operative, as well as postoperative conditions including an ostomy pouch used by the patient. Postoperatively, it is important for medical professionals to perform individualized fitting of ostomy pouches, and track changes in stoma size and shape so that a leak and odor proof seal may be created around the pouch and peristomal skin health may be maintained.

Over 750,000 individuals in the United States live with a stoma, and 130,000 individuals undergo a procedure resulting in a stoma each year. Stomal complications are relatively common, with a 34% complication rate over a twenty year period at Cook County Hospital from around 1,600 patients. (J J Park, A Del Pino, C P Orsay, R L Nelson, R K Pearl, J R Cintron, H Abcarian. Stoma complications: the Cook County Hospital experience. Dis Colon Rectum. 1999 December; 42(12):1575-80. doi: 10.1007/BF02236210).

Peristomal skin irritation is also relatively common, occurring in up to 42% of patients. FIG. 6 is a picture of an example of peristomal skin complications. Understanding of the temporal shift in dimensions of a stoma may provide a means for reducing these complications. In a study, patients were educated about their stoma and possible associated problems prior to surgery using three-dimensional (3D) printed models. The patients in the study had fewer skin problems that are commonly associated with daily stomal care and were able to be more self-reliant.

A common method for intestinal stoma imaging is contrast enhanced-computer tomography (CT). In CT, multiple x-rays from different angles may be taken to produce cross sectional images of a target. However, radiologists often overlook stoma sites when interpreting CT studies. This can often cause complications, as abnormalities are not recognized in the imaging process. The CT is also relatively expensive, as a radiologist is required to look at the CT studies by hand.

Another imaging technique is CT combined with a stomal enema. This technique is achieved by initially using unenhanced acquisition of the target area, followed by a contrast enhanced CT using injection of contrast mediums, such as iopamidol (Bracco) or iopromide (Schering Pharma). This is also considered relatively expensive and is only used for selected patients. MRI imaging may be used, for example, for younger patients who may require continual imaging throughout their lives.

Options for imaging a stoma and peristomal skin are limited. Further, examination of images can require continuous imaging assessment by trained medical personnel and can be problematic for some ostomates, for example, younger ostomates and those who are unable to be in constant communication with medical professionals.

Accordingly, it is desirable to provide improved stoma imaging and measuring tools and methods to better understand, detect, and potentially prevent peristomal and stomal conditions to maintain health thereof and for improved ostomy appliance fittings.

### SUMMARY

Tools and methods of imaging a stoma are provided according to various embodiments to increase understanding of temporal changes in stoma topography, dimensions, and volume which can guide improved ostomy product development. Post-surgical swelling and tissue remodeling causes changes in stoma size and shape over time. Understanding these changes can lead to treatment and appliance fitting algorithms, improvements in patient education, and novel product designs. The stoma imaging and measurement tools and methods may be configured to enable developers and clinicians to better understand, diagnose, and predict stoma qualities and conditions via computational image analysis.

In one aspect, a stoma imaging method may comprise obtaining a 2D image of a stoma and generating a 3D image of the stoma from the 2D image. In an embodiment, the 2D image may first be converted into a grayscale and plotted into the 3D image. In another embodiment, the 2D image may be converted into a holographic image, which may be converted to the 3D image. In some embodiments, multiple 2D images (e.g. rapidshot) or fast acquisition method may be used.

In an embodiment, the stoma imaging method may further include determining at least one dimension of the stoma from the 2D image, which may be performed using an algorithm including a bounding box method to determine a height and a width of the stoma in real time. The height and/or width measurements may be used to calculate a volume of the stoma and/or to assign a shape classification to the 2D image (See FIGS. 3, 4A, 4B, 5A, and 5B), wherein a calibrating scale may be used and/or a range finding apparatus may be used to assign real world values of scale to the 2D image.

Further, changes in dimensions, shape, and/or volume of the stoma over time may be collected, analyzed, and used to instruct treatment algorithms, product designs, and/or product recommendations. The collected data may also be used to instruct predictive algorithms, for example, artificial intelligence, to guide users to alter their application procedures, product selection (for example, convexity), and/or product dimensions to prevent peristomal skin complications.

In an embodiment, the stoma imaging method may include generating contours of the stoma using the 2D image. In some embodiments, the method may analyze and determine margins of the stoma and peristomal skin using predefined thresholds, or may use a contralateral skin to guide an algorithm (see FIG. 2). Alternatively, a user or clinician may instruct the method by denoting and demarking areas of stoma, peristomal skin and unaffected skin in the 2D image.

In an embodiment, a topography of a peristomal skin may be imaged, measured and modeled using the foregoing methods described regarding quantifying the stoma.

The step of plotting the grayscale into the 3D image may include determining a depth of each pixel in the grayscale from an intensity value of the pixel, wherein the intensity value may range from black to white. The intensity value may be plotted as a z-axis in the 3D image. In some embodiments, the stoma imaging method may further include a scaling process, wherein the z-axis is scaled based on estimated pixel-based height and width measurements.

In some embodiments, the stoma imaging method may also determine the color of the stoma and/or peristomal skin from the 2D image. The color of the stoma and/or peristomal skin may be measured using the foregoing imaging and analysis methods described regarding quantifying the stoma. The color values may be measured using the HSV (Hue Saturation Value) Color Scale and/or may incorporate a calibrating color scale. In some embodiments, the imaging/thresholding method may also be used to determine the color of individual's skin from the 2D image.

In an embodiment, redness is defined using a specific hue range in the HSV colorspace. In this embodiment, a redness filter identifies ranges of red colors from a specific background. A red hue may have pixel values in the ranges [0,10] and [160-180]. The redness filter may be, for example, a Python OpenCV filter. The redness filter may perform differently based on a use of a flash when taking the stoma image. FIG. 9A shows an image of a stoma with a flash. FIG. 9B shows an image of a stoma without a flash. In an embodiment, the redness filter works best when a flash is used to capture the stoma image.

In an embodiment, the stoma imaging method may further include a 3D image clean-up step using a background subtraction process. The stoma imaging method may include a stoma or surrounding peristomal skin identification step using a background or contralateral skin image subtraction process.

In another aspect, a stoma imaging method may comprise obtaining a 2D image of a stoma and determining at least one characteristic of the stoma from the 2D image. In an embodiment, the at least one characteristic of the stoma may be determined using an algorithm that includes a bounding box method to identify a height and a width of the stoma in a real time. The stoma imaging method may also generate contours of the stoma using the 2D image and determine the color of the stoma from the 2D image. For example, the stoma imaging method may be configured to determine a redness of the stoma and peristomal skin and/or temporal changes in the pigmentation of the peristomal skin, which may be indicative of adaptation to serial mechanical or chemical injury.

In embodiment, the 2D image may be quantified using the HSV Color Scale, which provides a numerical value that corresponds to color in degrees from 0 to 360.

In an embodiment, the stoma imaging method may include a capture and averaging of multiple images to increase resolution, decrease noise or reduce artifacts.

In another aspect, an imaging method may comprise obtaining an image of an anatomical site, obtaining a mask using a machine learning model trained to identify a stoma in the image, obtaining contours of the stoma based on the mask, and obtaining a contoured image of the anatomical site based on the contours of the stoma. The anatomical site includes a stoma.

In an embodiment, the machine learning model may use quantitative redness analysis to identify the stoma in the image. In some embodiments, the quantitative redness analysis may include analyzing red hue values of the image to identify a range of red objects from a background. The quantitative redness analysis may use a gaussian fit of redness peaks to generate parameters related to the stoma. The parameters may include a shape and perimeter of the stoma.

The foregoing methods and devices may also be used to quantify additional anatomical sites and indications, for example, but not limited to, the quantification of healing and/or closure of wounds and surgical sites, temporal changes of percutaneous interfaces (for example, a gastrostomy tube, tracheotomy, or osseointegrated prosthetic attachment hardware), subcutaneous implants, and/or the change in dimensions of soft tissue, as in tissue expansion for post-mastectomy staged breast reconstruction or transposition flap creation.

The foregoing methods and devices also be used to quantify additional pigmentation or color-changing applications and indications, for example, but not limited to, quantification of erythema and/or inflammation from injury (for example, microdermabrasion or fractional laser resurfacing), development and resolution of skin reactions to topical or systemic drugs, discoloration of scars or keloids, progress of tattoo removal, or treatment of hyperpigmentation, port wine stains, or vitiligo.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1A is an image of a stoma according to an embodiment;

FIG. 1B is a stoma contour representation generated from the stoma image of FIG. 1A according to an embodiment;

FIG. 2 is an illustration of a 2D stoma imaging method according to an embodiment;

FIG. 3 is a 3D image generated according to an embodiment;

FIG. 4A is a 3D image of a red stoma model on a white background according to an embodiment;

FIG. 4B is a 3D image of a gray stoma model on a carpet background according to an embodiment;

FIG. 5A is an image of a stoma model according to an embodiment;

FIG. 5B is a 3D stoma image of the stoma model of FIG. 5A prepared according to an embodiment;

FIG. 6 is a picture of an example of peristomal skin complications;

FIG. 7A is a side view of a sub/retracted stoma according to an embodiment;

FIG. 7B is a side view of a flush stoma according to an embodiment;

FIG. 7C is a side view of a low-profile stoma according to an embodiment;

FIG. 7D is a side view of a protruding stoma according to an embodiment;

FIG. 7E is a side view of a prolapsing stoma according to an embodiment;

FIG. 7F is a side view of a new stoma (edema) according to an embodiment;

FIG. 7G is a side view of a mature stoma according to an embodiment;

FIG. 7H is a side view of a loop stoma (2 lumens) according to an embodiment;

FIG. 7I is a front view of the loop stoma of FIG. 7H according to an embodiment;

FIG. 7J is a front view of a regular end stoma (round) according to an embodiment;

FIG. 7K is a front view of an out of bound stoma according to an embodiment;

FIG. 7L is a front view of an oval stoma according to an embodiment;

FIG. 7M is a front view of a double barrel stoma (separated) according to an embodiment;

FIG. 7N is a side view of a fistula according to an embodiment;

FIG. 7O is a front view of the fistula of FIG. 7N according to an embodiment;

FIG. 7P is a front view of a wound according to an embodiment;

FIG. 7Q is a side view of the wound of FIG. 7P according to an embodiment;

FIG. 8A is a processed image of a stoma according to an embodiment;

FIG. 8B is an image mask of a stoma according to an embodiment;

FIG. 9A is an image of a stoma with a flash according to an embodiment;

FIG. 9B is an image of a stoma without a flash according to an embodiment;

FIG. 10A is an image of a stoma according to an embodiment;

FIG. 10B is a mask of the stoma image of FIG. 10A according to an embodiment;

FIG. 10C is the stoma image of FIG. 10A with contour according to an embodiment;

FIG. 11 is an imaging method for imaging an anatomical site according to an embodiment;

FIG. 12 is another imaging method for imaging an anatomical site according to an embodiment;

FIG. 13 is another imaging method for imaging an anatomical site according to an embodiment;

FIG. 14 is a computing system according to an embodiment;

FIG. 15 is a gaussian fit of model with a yellow background according to an embodiment; and

FIG. 16 is a double gaussian fit of model with a yellow background according to an embodiment.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

Imaging of a stoma and peristomal skin can help better understand and detect dermatological complications in peristomal skin and changes in stomal shape, size, and positions to promote improved ostomy appliance fitting and maintain ostomy skin health. Common challenges associated with stomas include skin irritation and leakage, which make self-care post-operation difficult to manage. Improper stoma installation and site selection are considered one of the most common and early complications of stoma surgery. It is more difficult to use stoma appliances when this occurs, due to injury at the attachment site, and leakage is more likely to happen.

Using 3D modeling of a stoma to find cases in which there is improper site selection can assist with providing insights for surgeons, enterostomal nurses, patients, caregivers, and product designers. 3D modelling may also be used to predict vascular compromise arising in the long term from stoma failure, which can cause intestinal and stomal necrosis, among others. Further, 3D modelling may assist in determining whether there have been complications that have latent symptoms in patients.

Automated imaging methods according to various embodiments of the present disclosure may be configured to reduce inconveniences and problems of the known imaging methods, to provide clinical research tools, and to detect abnormalities before an onset of symptoms. Sporadic imaging or scheduled imaging of a stoma may enable medical professionals to recognize latent or subclinical symptoms. Further, the imaging method may be configured for easy data collection, which may be performed by an ostomate. Such ease of data collection can increase data collection across demographics and allow for non-invasive longitudinal studies.

In an embodiment, a stoma imaging method may comprise collecting and analyzing two-dimensional (2D), three-dimensional (3D) and pigmentation information of a stoma and/or the surrounding peristomal skin.

2D Parameters

In an embodiment, a stoma imaging method may be configured to obtain a 2D image of a stoma and peristomal skin area and determine various dimensions and characteristics thereof from the 2D image. For example, the stoma imaging method may be configured to estimate width, height, area, and volume of the stoma and peristomal skin, depth/height of the stoma, color (e.g. redness) of the stoma and peristomal skin, and any changes thereof.

In an embodiment, the stoma imaging method may comprise an algorithm including a bounding box method to find height and width dimensions in real time. The algorithm may be configured to determine dimensions of a target on an object with known dimensions. In an embodiment, the algorithm may be configured to determine various dimensions of a stoma from a 2D stoma image in real time. The bounding box method, for example, may include determining the outer boundaries of a stoma in an image. The outer boundaries of the stoma may be determined using various methods including determining edges in the image based on a color analysis.

In an embodiment, the stoma imaging method may apply the bounding box method from within OpenCV package or other similar codes to determine a shape of the stoma. From the selected shape, distances in pixels may be measured calibrated to the real-world measurements of the target stoma model. The same steps may be applied to several target stoma models to create a mapping. Table 1 shows an example mapping.

TABLE 1
Examples from one stoma model

| Measurement | Pixels | cm |
|---|---|---|
| Width x | 1300 | 3.2 |
| Width y | 1200 | 3.1 |

In an embodiment, the stoma imaging method may be configured to capture color or pigmentation of a stoma to identify a condition of the stoma health. For example, the stoma imaging method may be configured to determine the redness of the stoma and/or peristomal skin. In such an embodiment, the stoma imaging method may provide an algorithm configured to define a red color as a specific hue range in the HSV colorspace. The algorithm may comprise a Python OpenCV redness filter or other similar codes configured to identify ranges of red from a specific background. The stoma imaging method may be configured to take a 2D image of the stoma using a flash and ambient shadow and lighting effects minimized to optimize the redness determination. In some embodiments, the stoma imaging method may be configured to analyze the redscale of an RGB image or HSV color scale to map a change in the redness of the stoma and peristomal skin area over time. A change in the redness of the stoma and/or peristomal skin may be used to predict or identify stoma or peristomal skin complications.

In an embodiment, the stoma imaging method may comprise the step of generating contours of a stoma. The stoma contours may be generated from a single image. By generating a contour, a qualitative description of the stoma shape, as well as quantitative information concerning the peristomal area and circumference of the stoma may be obtained. The step of generating contours of a stoma may include obtaining an image having a sufficient contrast. The image of a stoma having the sufficient contrast may be taken using a flash.

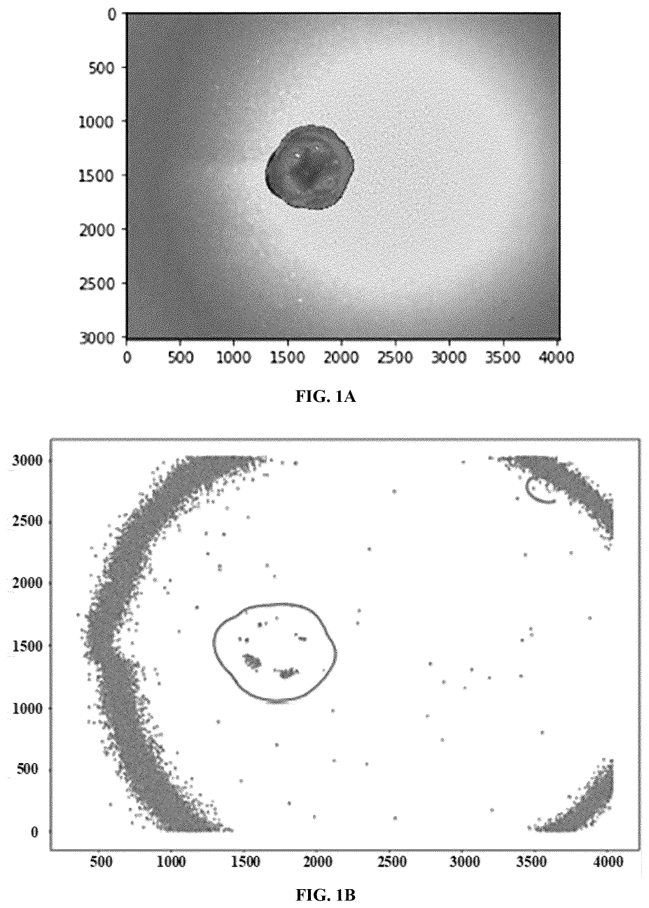

FIG. 1B shows a stoma contour representation generated from a stoma image of FIG. 1A from Scikit package at half height according to an embodiment. As shown in FIGS. 1A and 1B, the stoma imaging method may provide a qualitatively plausible representation of a stoma contour. In an embodiment, the stoma imaging method may generate a stoma contour representation using an algorithm configured to minimize noise in a stoma contour representation. The noise in the stoma contour may make a stoma contour plotting relatively intensive and long and may also distract from the main stoma contour. In such an embodiment, the stoma imaging method may be configured to determine and provide area and circumference measurements from the stoma contour representation.

The stoma contour representation may utilize K-means clustering that generates “cluster centers” based on a set of initial guesses and determines in an N-dimensional space how close certain points are to these initial guesses. After iteratively updating the position the cluster centers are updated to be closest to the “true clusters” in a dataset. The distance metric may include the following exploratory variables: contour length, contour center, redness sum, redness centroid (Gaussian fit), redness background height. A training data may be generated from the stoma models. This analysis may be performed using about 100 images for each stoma taken in the same conditions. Other forms of clustering may be utilized, like balanced iterative reducing and clustering using hierarchies (BIRCH), Clustering Using Representatives (CURE), hierarchical, expectation-maximization (EM), mean shift, density-based spatial clustering of applications with noise (DBSCAN), ordering points to identify the clustering structure (OPTICS), and others. A multiple linear regression algorithm, structure prediction models like graphical models may also be used.

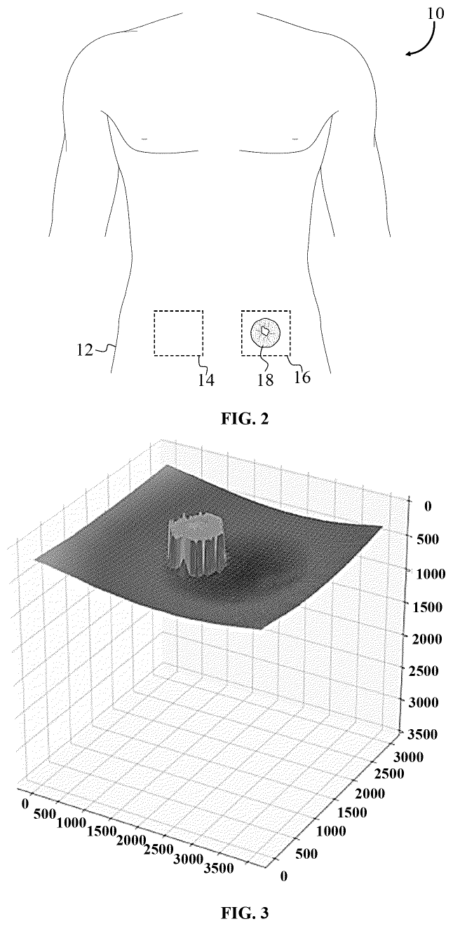

In an embodiment, the stoma imaging method may compare an image of a peristomal skin area against an image of a “normal abdominal skin area” to identify margins of a stoma as shown in FIG. 2. FIG. 2 includes obtaining a stoma by subtracting a second image with a stoma from a first image without a stoma.

FIG. 2 shows a human torso 10 with a stoma 18. In an embodiment, two or more images can be taken of the lower abdomen area of the torso 10, near 12. The first image includes an anatomical site in area 14, which includes “normal abdominal skin area.” The second image includes a second area 16, which includes the stoma 18. In the embodiment, the second image is subtracted from the first image to identify the stoma 18.

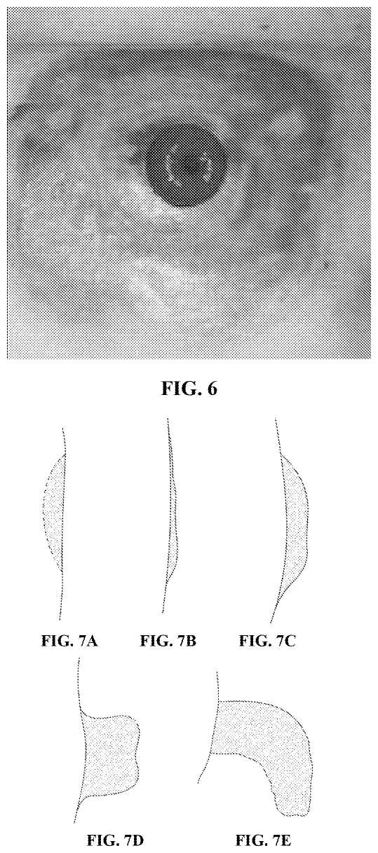

In an embodiment, the stoma imaging method may be configured to track changes in an area and shape of the stoma, which may be indicators of the stoma health and/or normal anatomical post-surgical healing and remodeling. The changes in the area and shape of the stoma may be signs of infection and other stoma conditions, or a normal remodeling process as the stoma matures. FIG. 6 shows complications of a peristomal skin around the stoma. The complications can result in red marks that may affect the processing of a stoma image.

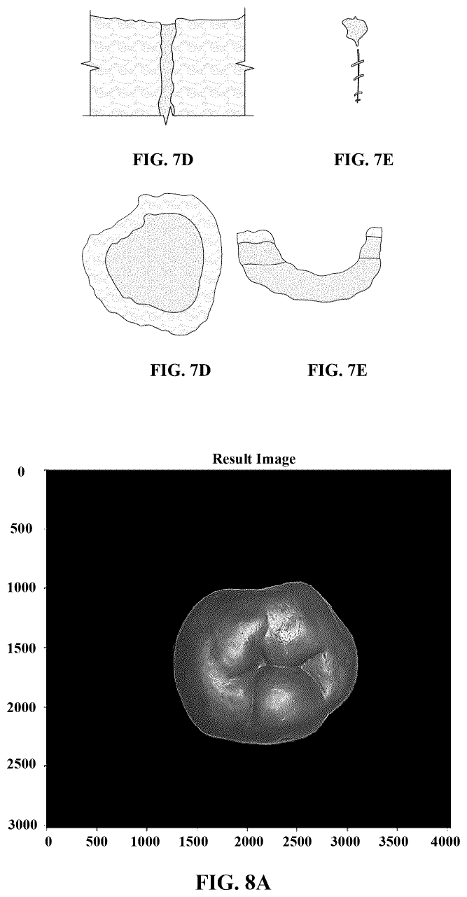

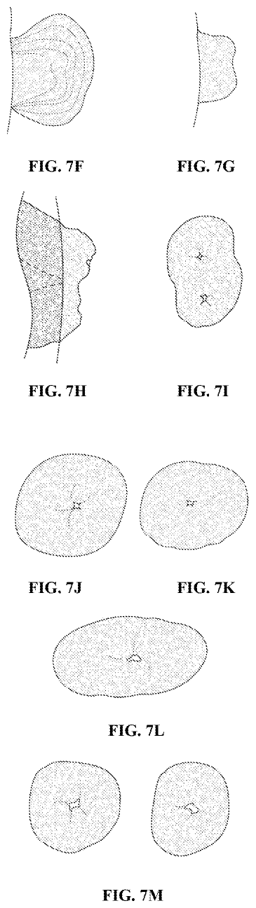

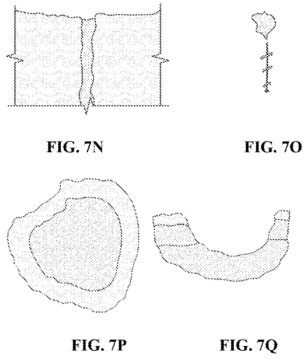

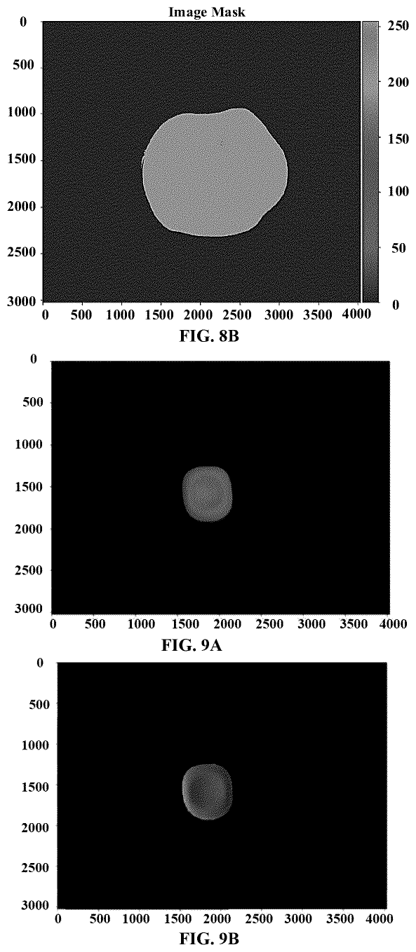

FIG. 7A-Q is illustrations of stoma profiles and types. The stoma profiles have different sizes, depths, shapes, and colors.

2D to 3D Modeling

In an embodiment, the stoma imaging method may further comprise the step of generating a 3D model from a 2D image of a stoma. The step of generating 3D model may include converting an RGB image into a grayscale via an algorithm. The depth of each pixel in the grayscale may be ascertained from the intensity value of the pixel, which ranges from black to white. The grayscale may then be plotted into a 3D image, with the pixel intensities acting as a z-axis. The 3D modeling step may further include a scaling process, wherein an algorithm may take in estimated pixel-based height and width measurements and scales the z-axis to these numbers. In some embodiments, the 3D modeling step may analyze the redscale of an RGB image in conjunction with the grayscale to generate a 3D image. The stoma imaging method may be configured to provide a 3D image that looks qualitatively similar to the target stoma.

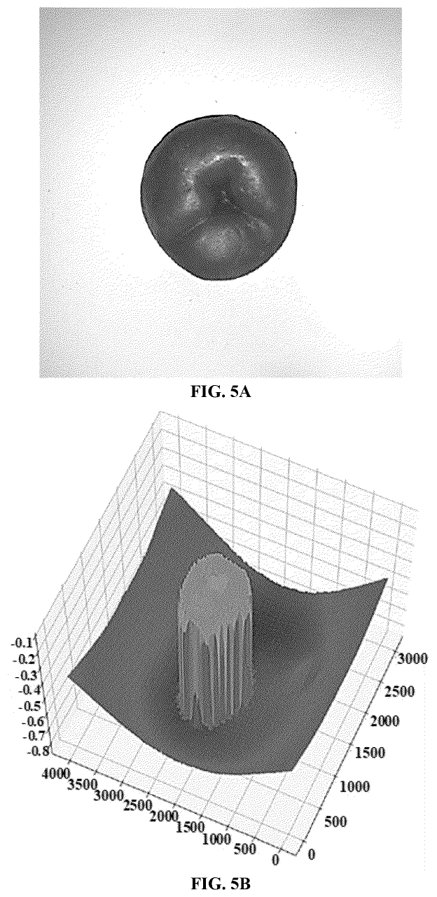

FIG. 3 is a 3D stoma image taken at half-height according to an embodiment. In an embodiment, the 3D modeling step may include a clean-up step. In such an embodiment, the 3D image of FIG. 3 may be cleaned up to delete a few artifacts. For example, the curvature in the surface due to the flash and the plotting algorithm simply interpreting the changing pixel intensities over that region as a changing depth may be cleaned up. In an embodiment, the clean-up step may use a background subtraction process. FIG. 5B is a 3D stoma image of a stoma model shown in FIG. 5A prepared via the grayscaling 3D modeling method according to an embodiment. FIG. 5B shows a depth perception of the stoma based on grayscale processing.

In an embodiment, pictures of a stoma in different lighting conditions and using different stoma color/background color contrasts may be taken to better gauge the effectiveness of the grayscale method in different conditions. To ensure fair assessment of images and to obtain useful data, a testing rig was created to keep the height, image quality, and image stability consistent across images, while changing the parameters of interest. About 50 useful comparison images were generated and analyzed to identify critical parameters to optimize the 3D model quality.

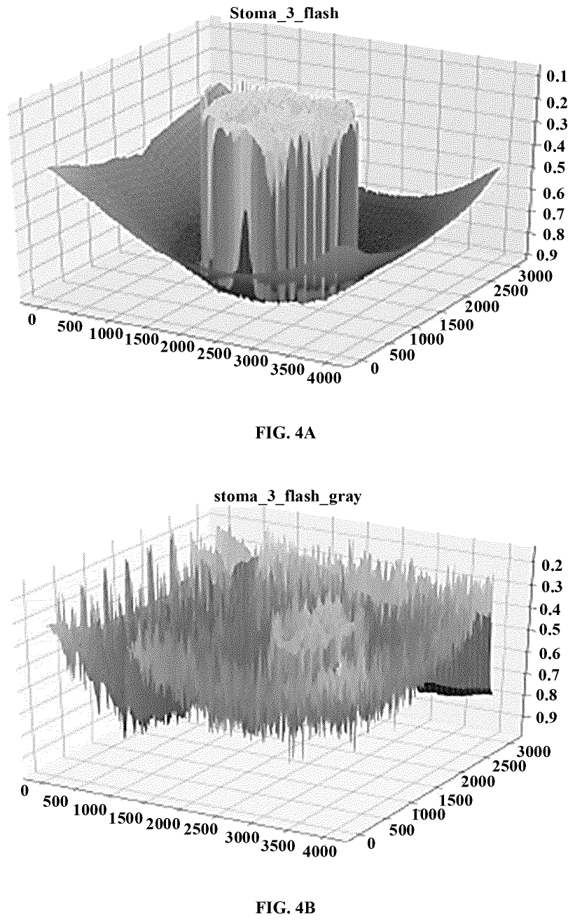

FIGS. 4A and 4B show a comparison of two 3D images of the same stoma model but with different colors. As shown in FIGS. 4A and 4B, the reflectance of the background and the color contrast between the stoma and the background make significant differences in the 3D images. FIG. 4A is a 3D image of a red stoma model on a white background. FIG. 4B is a 3D image of a gray stoma model on a carpet background. As shown in FIG. 4B, the stoma can just barely be distinguished when prepared using a gray/carpet contrast. In an embodiment, the 3D modeling step may include a background subtraction process configured to improve the quality of the 3D image. In some embodiments, the method may comprise a machine learning process configured to be trained to look for the stoma and separate it from the background. Further, a stoma classification system may be developed to classify stoma images and to facilitate the machine learning process.

The machine learning process may include using trained machine learning models that identify a stoma in an image. The machine learning models may include deep learning models that utilize neural networks to process the image based on redness values. The machine learning models may be trained, for example, using several hundred images of a stoma at different angles and under different lighting conditions or using a still frames of a video of a stoma. The machine learning models may be trained using approximately 80% of the total images while reserving 20% of them for testing.

FIG. 8A shows a processed image of a stoma based on a mask shown in FIG. 8B.

Quantitative redness analysis may be used to analyze the redness value of the stoma image in order to generate a mask. The analysis may include looping through values in a redness range (160, 10), checking how the mask sum changes and taking the largest sum. The mask sum is then analyzed to determine the best mask for identifying a stoma in an image. A machine learning model may be used to generate the mask using the quantitative redness analysis. Redness analysis may use a gaussian fit of redness peaks to generate precise parameters related to the stoma (shape and perimeter of the stoma). The redness can be quantized by taking a single value mask (i.e. the range [160,161]) and iteratively applying these masks to the stoma image. By summing the resulting mask values (which become a 0 or 1) the amount of each “color” in the image may be quantified.

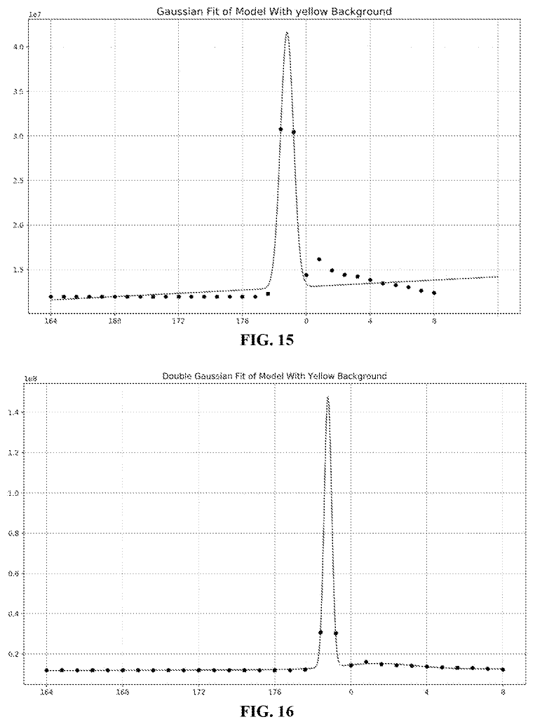

A gaussian model may include the following equation (1), with a resulting gaussian fit model with the image of a stoma having a yellow background, as shown in FIG. 15. In FIGS. 15 and 16 (described below) on the x axis is the “Hue” value in the HSV colorspace, and on the y-axis is the unscaled “color intensity” which is just the sum of the image mask.

Gauss(x)=ae^{-((x-b)}^{²}^{/2c}^{²}⁾+dx+e (1)

A double-Gaussian distribution can be used when the stoma has certain backgrounds that make it difficult to identify the contours of the stoma. The double-Gaussian distribution includes the following equation (2), with a resulting double gaussian fit model with the image of a stoma having a yellow background, as shown in FIG. 16.

DGauss(x)=Gauss(a,b,c)+Gauss(d,e,f)+gx+h (2)

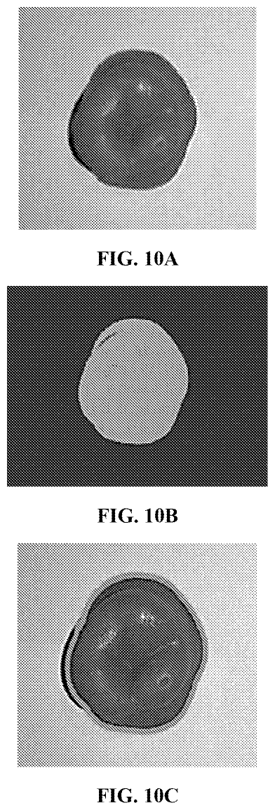

In an embodiment, a contour method may be used to generate a stoma image with contours for identifying the outline of a stoma. An image of a stoma, as shown in FIG. 10A, is processed to generate a mask of the stoma, as show in FIG. 10B. The mask of the stoma may then be used to generate a contour around the image of the stoma, as show in FIG. 10C.

FIG. 11 shows an imaging method 1100 for imaging an anatomical site in accordance with an embodiment. The method may be, for example, applied to a computing device.

In step 1101, the computing device may obtain a 2D image of an anatomical site. The 2D image may also be a photograph or video of the stoma at a certain distance and under certain lighting conditions. The 2D image may also be, for example, a CT, MRI or other medical image of the stoma.

In step 1102, the computing device may convert the 2D image into grayscale. The grayscale, for example, may be a grayscale image.

In step 1103, the computing device may plot the grayscale into a 3D image. The grayscale may be done based on the intensity of the grayscale at each pixel. The grayscale can be used to generate contours of the stoma in the image.

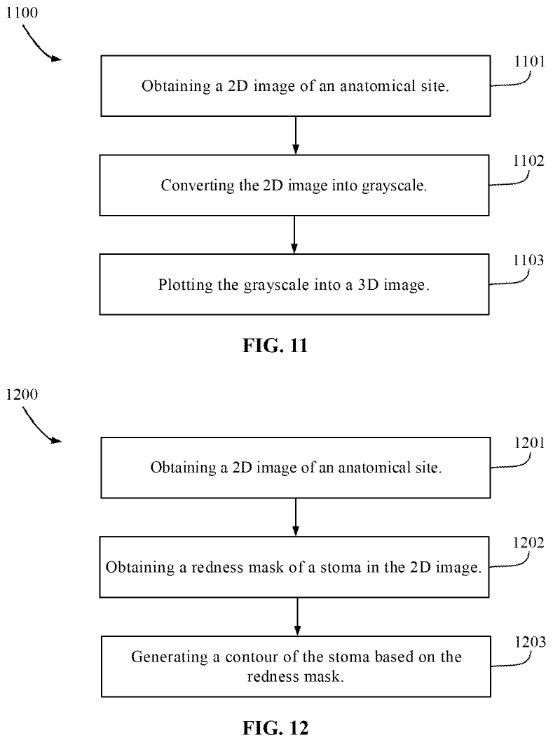

FIG. 12 shows an imaging method 1200 for imaging an anatomical site according to another embodiment. The method may be, for example, applied to a computing device.

In step 1201, the computing device may obtain a 2D image of an anatomical site. The 2D image may also be a photograph or video of the stoma at a certain distance and under certain lighting conditions. The 2D image may also be, for example, a CT, MRI or other medical image of the stoma.

In step 1202, the computing device may obtain a redness mask of a stoma in the 2D image. The computing device, for example, may include a machine learning algorithm trained to obtain the redness mask based on a redness range. The machine learning algorithm may use redness analysis to identify a range of red objects from a background.

In step 1203, the computing device may generate a contour of the stoma based on the redness mask. The computing device, for example, may use a shape and contour analysis to find a shape and perimeter of a stoma.

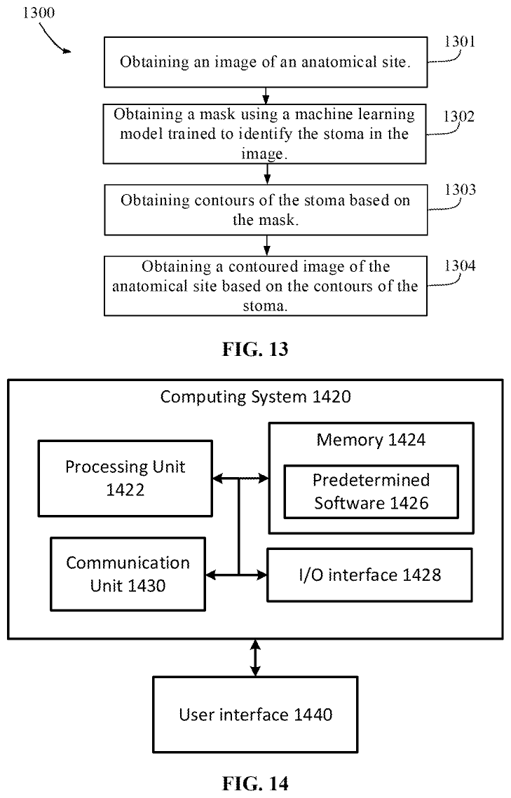

FIG. 13 shows an imaging method 1300 for imaging an anatomical site according to another embodiment. The method may be, for example, applied to a computing device.

In step 1301, the computing device may obtain an image of an anatomical site. The anatomical site comprises a stoma. The anatomical site, for example, may include a stoma surrounded by red marks resulting from complications, as shown in FIG. 6.

In step 1302, the computing device may obtain a mask using a machine learning model trained to identify the stoma in the image. The machine learning model, for example, may be trained to find a range of redness values that can generate a mask for identifying a stoma in an image. The machine learning model, for example, may also be trained to use a grayscale image to generate a mask for identifying a mask for stoma in an image.

In step 1303, the computing device may obtain contours of the stoma based on the mask. The mask, for example, may be used to separate the stoma from the background of the image. For example, in the image, a stoma may be separated from red marks on the anatomical site.

In step 1304, the computing device may obtain a contoured image of the anatomical site based on the contours of the stoma. The contoured image, for example, may be an image of a stoma with an outline of the edges of the stoma, as shown in FIG. 10C. The contoured image may be displayed to a user. The countered image may also be used to calculate the dimensions, size, and depth of the stoma, including the different stoma profiles and types shown in FIG. 7A-Q.

FIG. 14 shows a computing system 1420 coupled with a user interface 1440 according to an embodiment. The computing system 1420 may be part of a data processing server or mobile terminal. The computing system 1420 includes processor 1422, memory 1424, and I/O interface 1428.

The processor 1422 typically controls overall operations of the computing system 1420, such as the operations associated with the display, data acquisition, data communications, and image processing. The processor 1422 may include one or more processors to execute instructions to perform all or some of the steps in the above-described methods. Moreover, the processor 1422 may include one or more modules that facilitate the interaction between the processor 1422 and other components. The processor may be a Central Processing Unit (CPU), a microprocessor, a single chip machine, a GPU, or the like.

The memory 1424 is configured to store various types of data to support the operation of the computing system 1420. Memory 1424 may include predetermine software 1426. Examples of such data comprise instructions for any applications or methods operated on the computing system 1420, video datasets, image data, etc. The memory 1424 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 1428 provides an interface between the processor 1422 and peripheral interface modules, such as a keyboard, a click wheel, buttons, and the like. The buttons may include but are not limited to, a home button, a start scan button, and a stop scan button. The I/O interface 1428 can be coupled with an encoder and decoder.

Communication Unit 1430 provides communication between the processing unit and an external device. The communication can be done through, for example, WIFI or BLUETOOTH hardware and protocols. The communication unit 1430 may communicate with a CT machine, MRI machine, medical device, photo camera, video camera or other imaging system to obtain or capture an image for processing.

User interface 1440 may be a mobile terminal or a display.

In some embodiments, there is also provided a non-transitory computer-readable storage medium comprising a plurality of programs, such as comprised in the memory 1424, executable by the processor 1422 in the computing system 1420, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing system 1420 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

It is understood that the relative directions described above, e.g., “upward,” “downward,” “upper,” “lower,” “above,” “below,” are used for illustrative purposes only and may change depending on an orientation of the ostomy pouch and/or the patient. Accordingly, this terminology is non-limiting in nature. In addition, it is understood that one or more various features of an embodiment above may be used in, combined with, or replace other features of a different embodiment described herein.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. An imaging method for imaging an anatomical site, comprising the steps of:
obtaining a 2D image of the anatomical site; and
generating a 3D image from the 2D image of the anatomical site, comprising the steps of:
converting the 2D image into a grayscale; and
plotting the grayscale into the 3D image.

2. The imaging method of claim 1, wherein the anatomical site is a stoma and/or a peristomal skin.

3. The imaging method of claim 1, further including determining at least one dimension of the anatomical site from the 2D image.

4. The imaging method of claim 3, wherein the step of determining at least one dimension is performed using an algorithm including a bounding box method to identify a height and a width of a stoma in a real time.

5. The imaging method of claim 1, further including generating contours of the anatomical site using the 2D image.

6. The imaging method of claim 1, wherein the step of plotting the grayscale into the 3D image includes determining a depth of each pixel in the grayscale from an intensity value of the pixel, wherein the intensity value ranges from black to white, and wherein the intensity value is plotted as a z-axis.

7. The imaging method of claim 6, the step of plotting the grayscale into the 3D image further includes a scaling process, wherein the z-axis is scaled based on estimated pixel-based height and width measurements.

8. The imaging method of claim 1, wherein the step of plotting the grayscale into the 3D image further includes a clean-up step using a background subtraction process.

9. The imaging method of claim 1, further including determining a color of the anatomical site from the 2D image.

10. An imaging method for imaging an anatomical site, comprising the steps of:
obtaining a 2D image of the anatomical site; and
determining at least one characteristic of the anatomical site from the 2D image.

11. The imaging method of claim 10, wherein the step of determining at least one characteristic is performed using an algorithm including a bounding box method to identify a height and a width of the anatomical site in a real time.

12. The imaging method of claim 10, further including generating contours of the anatomical site using the 2D image.

13. The imaging method of claim 10, further including determining a color of the anatomical site from the 2D image.

14. The imaging method of claim 13, wherein the step of determining a color of the anatomical site comprises determining a redness of the anatomical site or a contralateral skin.

15. The imaging method of claim 10, wherein the anatomical site is a stoma and/or a peristomal skin.

16. An imaging method comprising:
obtaining an image of an anatomical site, wherein the anatomical site comprises a stoma;
obtaining a mask using a machine learning model trained to identify the stoma in the image;
obtaining contours of the stoma based on the mask; and
obtaining a contoured image of the anatomical site based on the contours of the stoma.

17. The imaging method of claim 16, wherein the machine learning model uses quantitative redness analysis to identify the stoma in the image.

18. The imaging method of claim 17, wherein the quantitative redness analysis comprises analyzing red hue values of the image to identify a range of red objects from a background.

19. The imaging method of claim 17, wherein the quantitative redness analysis uses a gaussian fit of redness peaks to generate parameters related to the stoma.

20. The imaging method of claim 19, wherein the parameters comprise a shape and perimeter of the stoma.
